(19) United States
(12) Patent Application Publication
(10) Pub. No.: US 2026/0312353 A1
(43) Pub. Date: Oct. 8, 2026

(54) METHOD FOR FIXING TERMINAL MODULE TO CASE CONTAINING ELECTRONIC DEVICE AND STRUCTURE FOR FIXING TERMINAL MODULE TO CASE CONTAINING ELECTRONIC DEVICE

(71) Applicant: SMK Corporation, Tokyo (JP)

(72) Inventors: Satoru SUZUKI, Saitama (JP); Tadahito SASAKI, Kanagawa (JP)

(21) Appl. No.: 19/679,805

(22) Filed: May 18, 2026

Related U.S. Application Data
(63) Continuation of application No. PCT/JP2024/021196, filed on Jun. 11, 2024.

(30) Foreign Application Priority Data
Dec. 14, 2023 (JP) 2023-210984

(51) Int. Cl. H01R 43/20; H01R 13/73; H04N 23/51

(52) U.S. Cl. CPC H01R 43/20; H01R 13/73; H04N 23/51

(57) ABSTRACT

A method for fixing a terminal module to a camera case includes the steps of: disposing a thermal adhesive film on a flange receiving portion; inserting the terminal module into the through hole; after the insertion, further press-fitting the terminal module into an interior of the housing; after the press-fitting, crimping the terminal module; and after crimping, heating a periphery of the flange receiving portion. In the step of press-fitting the terminal module into the through hole, a press-fitting position of the terminal module is restricted at the first locking portion on the tip side of the terminal module by a first restriction portion. In the step of crimping the terminal module after the press-fitting, a crimping position of the terminal module is restricted at the second locking portion on the tip side of the terminal module by the second restriction portion.

### CROSS-REFERENCE TO RELATED APPLICATIONS

The contents of the following patent application(s) are incorporated herein by reference:

NO. 2023-210984 filed in JP on December 14, 2023

NO. PCT/JP2024/021196 filed in WO on June 11, 2024

### BACKGROUND

### 1. TECHNICAL FIELD

The present invention relates to a method for fixing a terminal module to a case containing an electronic device and a structure for fixing a terminal module to a case containing an electronic device.

### 2. RELATED ART

As a case containing an electronic device, a camera case accommodating a camera has heretofore been configured, for example, so that a terminal module for connecting a camera module, which includes the camera inside the camera case, to an external cable or the like, which enables electrical conduction is fixed thereto. To prevent liquid such as water from entering the interior, the structure for fixing the camera case and the terminal module is required to have high water proofness.

As a structure for fixing a camera case and a terminal module like this, a fixing structure has been disclosed that uses a method for disposing an external seal member 6 around a first cylindrical shell 3 of a terminal module 30, inserting the same into a plug case 10A, and crushing the first cylindrical shell 3 to form a plurality of locking ribs 32, whereby the first cylindrical shell 3 and the plug case 10A are fixed (see PTL 1). The fixing structure disclosed in PTL 1 prevents liquid from entering the cylindrical space of the plug case 10A by configuring the external seal member 6 to be in contact with the inner peripheral surface of the plug case 10A and the outer peripheral surface of the first cylindrical shell 3.

In fields related to that other than camera cases, such as smartphones and tablet terminals, a fixing method for fixing a terminal member 30 to a housing 10 in a waterproof manner has been disclosed in which a double-sided tape, an adhesive, or the like is used as a waterproof member 40 on a mounting surface of the terminal member 30 (see PTL 2).

### CITATION LIST

### PATENT LITERATURE

Patent Literature 1: Japanese Patent Application Laid-Open No. 2022-174604

Patent Literature 2: Japanese Patent Application Laid-Open No. 2021-166158

### BRIEF DESCRIPTION OF THE DRAWINGS

FIG. 1 is a schematic diagram showing a camera case according to an embodiment of the present invention.

FIG. 2A is a perspective view seen from above of a rear case according to the embodiment of the present invention.

FIG. 2B is a perspective view seen from below of a rear case according to the embodiment of the present invention.

FIG. 3A is a perspective view seen from above of a terminal module according to the embodiment of the present invention.

FIG. 3B is a perspective view seen from below of a terminal module according to the embodiment of the present invention.

FIG. 4 is a perspective view showing a thermal adhesive film according to the embodiment of the present invention.

FIG. 5 is an exploded perspective view showing a state before the terminal module is fixed to the camera according to the embodiment of the present invention.

FIG. 6 is a perspective view showing a state where the thermal adhesive film is disposed on a flange receiving portion in a process of fixing the terminal module to the camera case according to the embodiment of the present invention.

FIG. 7 is a perspective view showing a state where the terminal module is being inserted into a through hole of the rear case in the process of fixing the terminal module to the camera case according to the embodiment of the present invention.

FIG. 8 is a top view showing the state where the terminal module is being inserted into the through hole of the rear case in the process of fixing the terminal module to the camera case according to the embodiment of the present invention.

FIG. 9 is a sectional view showing the state where the terminal module is being inserted into the rear case in the process of fixing the terminal module to the camera case according to the embodiment of the present invention, taken along cross section A-A of FIG. 8.

FIG. 10 is a perspective view showing a state where the terminal module is press-fitted into the through hole of the rear case in the process of fixing the terminal module to the camera case according to the embodiment of the present invention.

FIG. 11 is a sectional view showing the state where the terminal module is press-fitted into the through hole of the rear case in the process of fixing the terminal module to the camera case according to the embodiment of the present invention, taken along cross section A-A of FIG. 8.

FIG. 12 is a perspective view showing a state where the terminal module is press-fitted into the through hole of the rear case and then crimped in the process of fixing the terminal module to the camera case according to the embodiment of the present invention.

FIG. 13 is a sectional view showing the state where the terminal module is press-fitted into the through hole of the rear case and then crimped in the process of fixing the terminal module to the camera case according to the embodiment of the present invention, taken along cross section A-A of FIG. 8.

FIG. 14 is a sectional view showing a state where the thermal adhesive film is heated after the crimping of the terminal module to the through hole of the rear case in the process of fixing the terminal module to the camera case according to the embodiment of the present invention, taken along cross section A-A of FIG. 8.

FIG. 15 is a sectional view showing a state where the terminal module is being crimped to the through hole of the rear case while the thermal adhesive film is heated in the process of fixing the terminal module to the camera case according to the embodiment of the present invention, taken along cross section A-A of FIG. 8.

FIG. 16 is a perspective view showing a state where the thermal adhesive film is disposed on a flange portion in the process of fixing the terminal module to the camera case according to the embodiment of the present invention.

### DESCRIPTION OF EXEMPLARY EMBODIMENTS

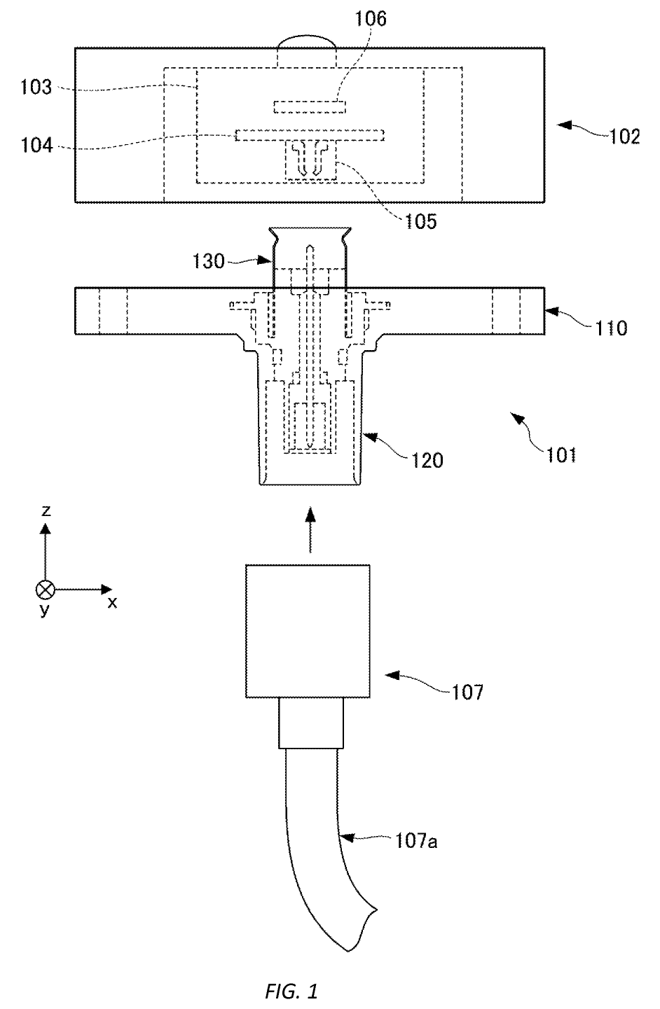

A camera case 101 according to the present embodiment will be described with reference to FIGS. 1 to 16.

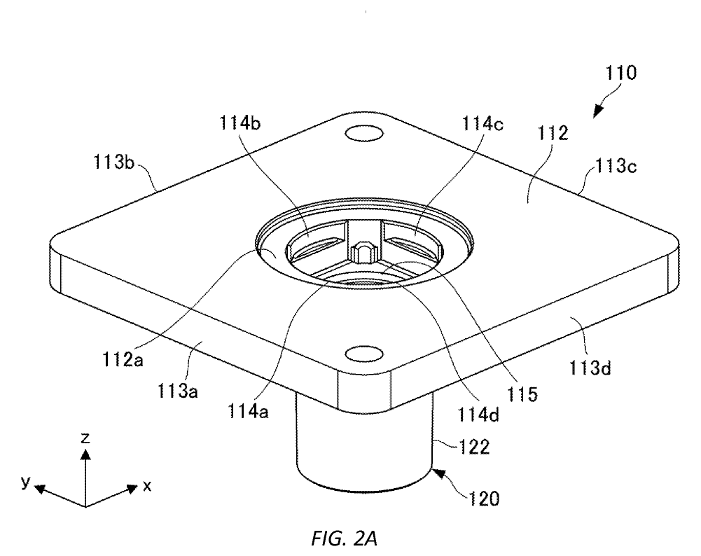

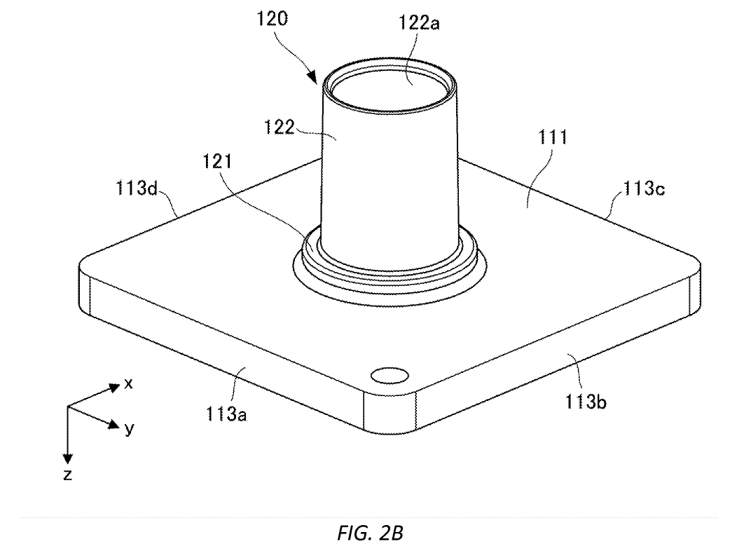

FIG. 1 is a schematic diagram showing a state before the camera case 101 according to the present embodiment is assembled. An X direction in FIG. 1 will be referred to as a lateral direction, a Y direction a depth direction, and a Z direction a height direction or axial direction. The same applies to FIG. 2 and subsequent diagrams. The positive side in the Z direction may be referred to as an upper side or base side, and the negative side as a lower side or tip side.

### Camera Case

As shown in FIG. 1, the camera case 101 includes a front case 102 and a rear case 110. The front case 102 and the rear case 110 of the camera case 101 are joined to face each other, and as a result, a space for accommodating a camera module 103 to be described below and the like is formed. The front case 102 and the rear case 110 are joined using an adhesive, for example, but may be joined by other mechanical methods or by methods such as welding. The camera case 101 constitutes a case containing an electronic device according to the present invention. The front case 102 constitutes a second case according to the present invention. The rear case 110 constitutes a first case according to the present invention. As employed herein, an electronic device refers to a camera or the like (including a smartphone and a tablet terminal). In the present embodiment, the camera case 101 that is a camera case for a vehicle-mounted camera will be described as an example. However, the camera case 101 is not necessarily a camera case for a vehicle-mounted camera, and may be a case that contains other electronic devices.

A terminal module 130 is fixed to the camera case 101 by a fixing method to be described below. With the terminal module 130 fixed to the camera case 101, an external connector 107 including a cable 107a and the camera module 103 are electrically connected via the terminal module 130 when the camera case 101 is assembled.

### Camera Module

The camera module 103 includes a camera substrate 104 and an image sensor 106. The camera module 103 is disposed in the accommodation space inside the camera case 101. The camera module 103 captures an image outside the camera case 101 through a lens hole formed in the front case 102.

The camera substrate 104 is a printed-circuit board (PCB), for example, and the image sensor 106 such as a CCD or CMOS is mounted thereon. The camera substrate 104 includes a substrate-side connector 105. The camera substrate 104 is electrically connected to the external connector 107 by the substrate-side connector 105 coming into contact with the terminal module 130 to be described below, and by the terminal module 130 coming into contact with the external connector 107.

### Front Case

The front case 102 accommodates the camera module 103, which includes the camera substrate 104 and the image sensor 106, and constitutes the camera case 101 when joined with the rear case 110 to be described below. In the present embodiment, the front case 102 is made of aluminum. However, the front case 102 may be made of other metals such as copper, or resins such as ABS and polycarbonate.

### Rear Case

The rear case 110 has a through hole 115 that is formed to extend from a rear case front surface 111 to a rear case inner surface 112 as shown in FIGS. 2A and 2B. The rear case 110 includes a cylindrical housing 120, which is described below and which communicates with the through hole 115 and protrudes outward from the camera case 101. The rear case 110 is joined with the front case 102 and thereby constitutes the camera case 101. In the present embodiment, the rear case 110 is made of aluminum. However, the rear case 110 may be made of other metals such as copper or resins such as ABS and polycarbonate.

As shown in FIGS. 2A and 2B, the rear case 110 has the rear case front surface 111, the rear case inner surface 112, and rear case side surfaces 113a, 113b, 113c, and 113d as its outer surfaces. The rear case inner surface 112 is a surface inside the camera case 101. A flange receiving portion 112a is formed around the outer rim of the through hole 115 in the rear case inner surface 112. The flange receiving portion 112a is an annular region recessed in the negative Z direction from the rear case inner surface 112. The flange receiving portion 112a is perpendicular to the Z direction and formed on an XY plane. A thermal adhesive film 160 to be described below can be disposed on the flange receiving portion 112a.

Inside the rear case 110, four rear case engagement portions 114a, 114b, 114c, and 114d are formed around the through hole 115. The rear case engagement portions 114a, 114b, 114c, and 114d are configured to engage with notched engagement portions 148a, 148b, 148c, and 148d of a shell 140 to be described below. In the present embodiment, four rear case engagement portions and four notched engagement portions are provided. However, the numbers of portions are not necessarily limited thereto, and the portions may be more in number or less in number.

On the lower side (negative Z direction) of the rear case front surface 111, the housing 120 to be described below is formed to protrude outward from the camera case 101. The housing 120 is configured so that the shell 140 press-fitted therein and the external connector 107 can engage with each other.

### Housing

The housing 120 is a cylindrical member that communicates with the through hole 115 of the rear case 110 and protrudes outward from the camera case 101. The housing 120 includes a base housing portion 121 on the base side (positive Z direction) and a cylindrical portion 122 on the tip side (negative Z direction). The terminal module 130 to be described below is inserted, press-fitted, and fixed to the interior of the housing 120.

The base housing portion 121 is formed on the rear case front surface 111 and has a diameter greater than that of the cylindrical portion 122. The cylindrical portion 122 is a cylindrical shaped portion formed on the base housing portion 121 and is hollow inside. The terminal module 130 to be described below can be inserted into the hollow interior of the base housing portion 121 and the cylindrical portion 122.

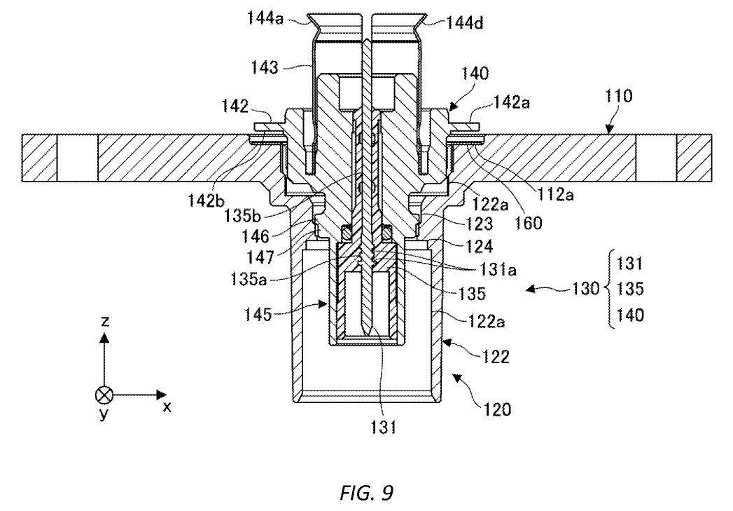

As shown in FIG. 9, a first restriction portion 123 and a second restriction portion 124 for restricting and fixing the movement of a first locking portion 146 and a second locking portion 147 of the shell 140 to be described below are formed on a cylindrical portion inner periphery 122a that is the inner surface of the cylindrical portion 122. The first restriction portion 123 is formed on the base side (positive Z direction) of the second restriction portion 124.

The first restriction portion 123 is a portion where a radial recess is formed in the cylindrical portion inner periphery 122a, this radial recess being in the positive Z-axis direction along the cylindrical portion inner periphery 122a relative to the second restriction portion 124, which will be described below. The recess forming the first restriction portion 123 has an inner diameter smaller than that of a stepped part formed by the second restriction portion 124. With the recess formed, the first locking portion 146 of the shell 140, when press-fitted into the housing 120, catches on the first restriction portion 123, and the axial movement is thus restricted. That is, the first restriction portion 123 determines the press-fitting position when the shell 140 is press-fitted into the housing 120.

The second restriction portion 124 is a portion located in front of the tip side in the positive Z-axis direction along the cylindrical portion inner periphery 122a, and where the inner diameter of the cylindrical portion inner periphery 122a is locally reduced to form a step. The second restriction portion 124 is formed on the tip side of the first restriction portion 123 in the axial direction of the cylindrical portion inner periphery 122a. The stepped part formed by the second restriction portion 124 has an inner diameter greater than that of the recess formed by the first restriction portion 123. With the step formed, the second locking portion 147 of the shell 140, when press-fitted into the housing 120 and then crimped, catches on the second restriction portion 124, and as a result, axial movement is restricted. That is, the second restriction portion 124 determines the position where the shell 140 is crimped in the housing 120.

In such a manner, the terminal module 130 is fixed to the camera case 101 at the tip side by being restricted by the first restriction portion 123 and the second restriction portion 124 formed in the cylindrical portion inner periphery 122a of the housing 120, and at the base side by the base flange portion 142 being fixed to the flange receiving portion 112a with the thermal adhesive film 160 as will be described below. The terminal module 130 is thus firmly and stably fixed to the camera case 101 compared to when the terminal module 130 is fixed only at one end side.

### Terminal Module)

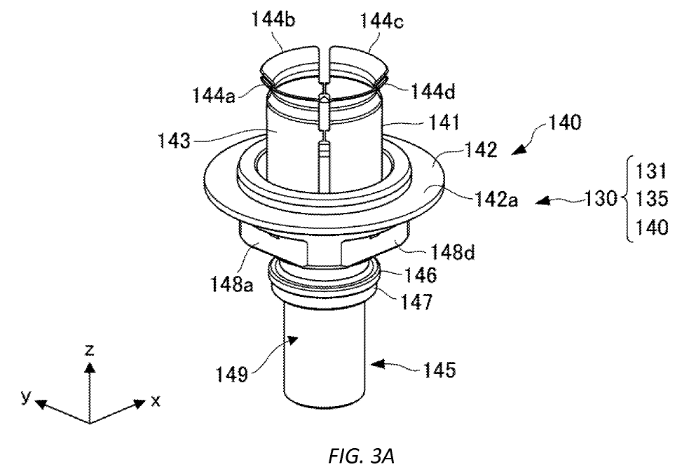

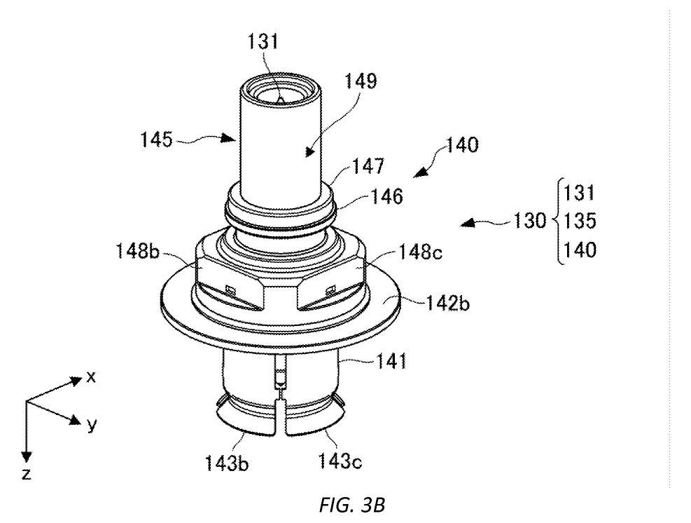

As shown in FIGS. 3A, 3B, and 9, the terminal module 130 includes the shell 140, a center contact 131, and an insulator 135. The terminal module 130 is fixed to the camera case 101 by being inserted into the through hole 115 in the rear case 110, then axially pressed toward the inside of the housing 120 and press-fitted into the through hole 115 and the housing 120, and is further heated.

The terminal module 130 is in contact with the external connector 107 at the tip side (negative Z direction) and is in contact with the substrate-side connector 105 of the camera substrate 104 at the base side, and as a result, the camera substrate 104 and the external connector 107 can be electrically connected.

### Shell

FIG. 3 shows the shell 140 according to the present embodiment. FIG. 3A is a perspective view seen from above (positive Z direction), and FIG. 3B is a perspective view seen from below (negative Z direction). The shell 140 is a conductor that is made of metal such as a zinc die-cast, for example, and has a cylindrical portion. The shell 140 includes a base shell portion 141 on the base side (positive Z direction) and a tip shell portion 145 on the tip side (negative Z direction). The shell 140 constitutes a shell according to the present invention.

As shown in FIG. 9, the center contact 131 to be described below and the insulator 135 to be described below, which is interposed between the shell 140 and the center contact 131 and holds the center contact 131, are disposed inside the shell 140 along the center axis.

The base shell portion 141 includes the base flange portion 142, a base cylindrical portion 143, and base pieces 144a, 144b, 144c, and 144d. As shown in FIGS. 3A and 3B, the base flange portion 142 is continuous with the tip shell portion 145 on the tip side, and has a diameter greater than that of the tip shell portion 145. The base flange portion 142 constitutes a flange portion according to the present invention.

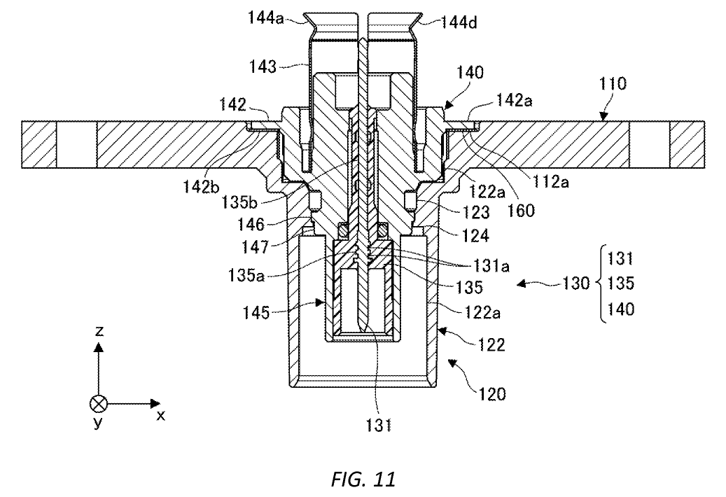

The base-side surface of the base flange portion 142 will be referred to as a base flange portion upper surface 142a, and the tip-side surface as a base flange portion lower surface 142b. As shown in FIG. 11, when the terminal module 130 is inserted and press-fitted into the through hole 115, the base flange portion lower surface 142b of the base flange portion 142 is in contact with the flange receiving portion 112a via the thermal adhesive film 160 to be described below.

The base cylindrical portion 143 is a cylindrical portion continuous with the base flange portion 142 at the base side. The base cylindrical portion 143 can be mated with the substrate-side connector 105 along with the base pieces 144a, 144b, 144c, and 144d to be described below.

The base pieces 144a, 144b, 144c, and 144d are four metal pieces continuous with the base cylindrical portion 143 at the base side, and without external load as shown in FIG. 3A, each bend outward to spread out relative to the base cylindrical portion 143. When the terminal module 130 is mated with the substrate-side connector 105, the base pieces 144a, 144b, 144c, and 144d are subjected to a load in the positive axial direction, and are thereby bent further outward and deformed.

The tip shell portion 145 is a portion continuous with the base flange portion 142 of the base shell portion 141 at the tip side. The tip shell portion 145 includes the notched engagement portions 148a, 148b, 148c, and 148d, and a tip cylindrical portion 149. The four notched engagement portions 148a, 148b, 148c, and 148d are formed on the base flange portion lower surface 142b, which is a lower surface of the base flange portion 142. In the present embodiment, four notched engagement portions are provided. However, the number of notched engagement portions is not necessarily limited thereto, and may be greater or fewer depending on the number of rear case engagement portions.

The notched engagement portions 148a, 148b, 148c, and 148d are formed by making notches to a circular columnar portion having a diameter smaller than that of the base flange portion 142 as shown in FIG. 3A. The notched engagement portions 148a, 148b, 148c, and 148d are configured to engage with the rear case engagement portions 114a, 114b, 114c, and 114d, respectively, when the terminal module 130 is inserted and press-fitted into the through hole 115 of the rear case 110.

The tip cylindrical portion 149 is a cylindrical portion continuous with the notched engagement portions 148a, 148b, 148c, and 148d at the tip side. The first locking portion 146 and the second locking portion 147 with locally increased diameters are formed on the outer periphery of the tip cylindrical portion 149. The first locking portion 146 is formed on the base side (positive Z direction) of the second locking portion 147.

As shown in FIG. 11, when the terminal module 130 is press-fitted into the housing 120 in the negative Z direction, the first locking portion 146 is pressed in and deformed to catch on the first restriction portion 123 of the housing 120, and as a result, the axial movement of the terminal module 130 is restricted.

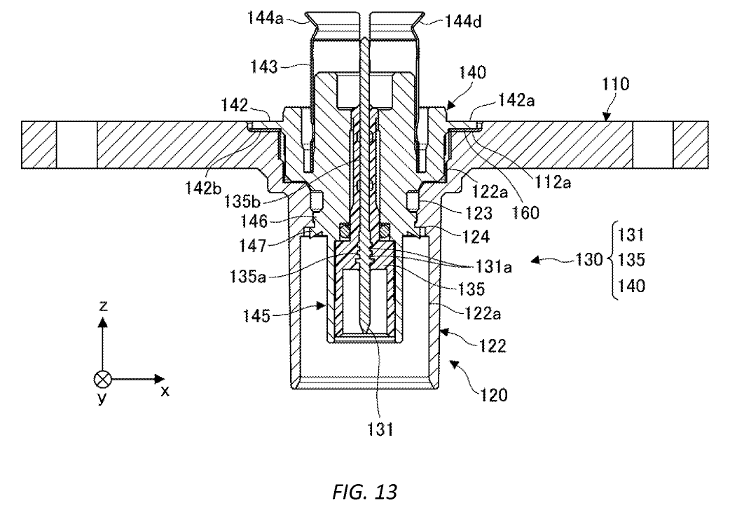

As shown in FIG. 13, when the terminal module 130 is press-fitted into the housing 120 in the negative Z direction and then crimped, the second locking portion 147 is pressed in and deformed to catch on the second restriction portion 124 of the housing 120, and as a result, the axial movement of the terminal module 130 is restricted.

In such a manner, the terminal module 130 is fixed to the camera case 101 at the tip side by being restricted by the first restriction portion 123 and the second restriction portion 124 formed on the cylindrical portion inner periphery 122a of the housing 120, and at the base side by the base flange portion 142 being fixed to the flange receiving portion 112a with the thermal adhesive film 160 as will be described below. The terminal module 130 is thus firmly and stably fixed to the camera case 101 compared to when the terminal module 130 is fixed only at one end side.

### Insulator

The insulator 135 is an insulating member that is interposed between the shell 140 and the center contact 131 to be described below and holds the center contact 131. The insulator 135 is formed of a resin such as polyamide, for example, and insulates the center contact 131 from the outside. The insulator 135 constitutes an insulating member according to the present invention.

As shown in FIGS. 11, 13, and the like, a through hole 135b for holding the center contact 131 along the center axis in the Z direction is formed in the insulator 135. A plurality of insulator engagement portions 135a to engage with engagement pieces 131a of the center contact 131 to be described below are formed in the inner periphery of the through hole 135b. The insulator engagement portions 135a engage with the engagement pieces 131a, and as a result, the center contact 131 is held by the insulator 135. The insulator 135 is fixed to the shell 140 by a not-shown fixing unit.

### Center Contact

The center contact 131 is disposed in the insulator 135 inside the shell 140 along the center axis of the shell 140. The center contact 131 is in contact with the substrate-side connector 105 at the base side (positive Z direction) and is in contact with the external connector 107 at the tip side (negative Z direction) for electrical conduction. The center contact 131 is formed of a copper alloy, for example, but may be formed of other metals.

As shown in FIGS. 11, 13, and the like, the plurality of radially protruding engagement pieces 131a are formed on the center contact 131. The engagement pieces 131a engage with the insulator engagement portions 135a, and as a result, the center contact 131 is held by the insulator 135.

### Thermal Adhesive Film

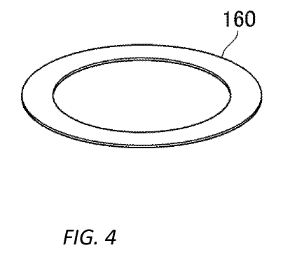

The thermal adhesive film 160 is a film that joins a plurality of members made of the same material or different materials by using heat. The thermal adhesive film 160 is applicable to hard-to-bond resins such as polypropylene and polyethylene, metal materials, and the like. The thermal adhesive film 160 adhesively bonds and fixes the flange receiving portion 112a of the rear case 110 and the base flange portion 142 of the terminal module 130. As shown in FIG. 4, the thermal adhesive film 160 has an annular shape and is sized to be capable of being disposed on the flange receiving portion 112a. While a thermal adhesive film is used in the present embodiment, a thermocompression bonding film or a thermocompression bonding sheet may be used as a similar adhesive means.

The thermal adhesive film 160 contains a thermoplastic resin as its compounding component and has substantially no tackiness at room temperature. The thermal adhesive film 160 can adhesively bond a plurality of members when heated to 150°C or higher, for example. The heating temperature may be changed depending on the physical properties of the thermal adhesive film 160. The thermal adhesive film 160 is heated using an induction heating device 161 after the step of press-fitting the terminal module 130 to be described below is performed. The induction heating device 161 may be a known induction heating device and can heat target members in a non-contact manner.

As the thermoplastic resin, any one of resins such as polyolefin-based resins, olefin-based thermoplastic elastomers, styrene-based thermoplastic elastomers, polyamide resins, polyvinyl acetate resins, polyacetal resins, polycarbonate-based resins, polyacrylic-based resins, polyamide-based resins, polyimide-based resins, polyvinyl acetate-based resins, phenoxy-based resins, and polyester-based resins is desirably used.

In such a manner, the terminal module 130 is fixed to the camera case 101 at the tip side by being restricted by the first restriction portion 123 and the second restriction portion 124 formed on the cylindrical portion inner periphery 122a of the housing 120, and at the base side by the base flange portion 142 being fixed to the flange receiving portion 112a with the thermal adhesive film 160. The terminal module 130 is thus firmly and stably fixed to the camera case 101 compared to when the terminal module 130 is fixed only at one end side.

Thermal adhesive films are typically used for the purpose of bonding members to each other. The applicant has found through repeated tests and research that the use of the thermal adhesive film 160 as a means for bonding the rear case 110 and the terminal module 130 not only provides adhesive bonding but also has the following features (1) to (4).

(1) Waterproof Function

The applicant has found that the use of the thermal adhesive film 160 to fix the terminal module 130 to the camera case 101 described below prevents liquid from entering the interior of the camera case 101 from the exterior of the camera case 101 through the through hole 115, or conversely, liquid from flowing out from the interior of the camera case 101 to the exterior of the camera case 101 through the through hole 115, and as a result, a waterproof effect for the camera case 101 is provided. The applicant has also found that this waterproof effect is equivalent to or higher than that when a seal member such as an O-ring is attached to the periphery of the terminal module 130 without using the thermal adhesive film 160. In the present embodiment, no seal member such as an O-ring is thus attached to the periphery of the terminal module 130.

(2) Reduction in Man-Hours

The use of the thermal adhesive film 160 to fix the terminal module 130 to the camera case 101 described below eliminates the need to attach a seal member such as an O-ring to the periphery of the terminal module 130 as described above. For example, if an O-ring is used, it is necessary to form a locking structure configured to lock the O-ring on the terminal module 130, deform the locking structure to fix the O-ring, and then insert and press-fit the terminal module 130 into the camera case 101 to fix the terminal module 130 to the camera case 101. The use of the thermal adhesive film 160 can thus reduce the man-hours for assembling the camera case 101.

(3) Workability

The thermal adhesive film 160 has no tackiness at room temperature and is easy to adjust in position. The thermal adhesive film 160 is thus relatively easy to dispose on the flange receiving portion 112a. Moreover, since the terminal module 130 can be fixed to the camera case 101 by simply heating the thermal adhesive film 160 after the terminal module 130 is press-fitted into the through hole 115 in the camera case 101, the operation is relatively easy.

(4) Fixing Function

The press-fitting of the terminal module 130 according to the present embodiment is achieved by the first restriction portion 123 restricting the first locking portion 146 as shown in FIG. 11. If the terminal module 130 is fixed to the camera case 101 by performing press-fitting at one location, the terminal module 130 formed long in the Z direction as a whole is fixed only at the one press-fit location in the Z direction. If the terminal module 130 is subjected to a force in the XY directions, a large force therefore acts on a location distant from the fixing point (for example, the protruding end on the base side of the center contact 131) by the principle of leverage, and displacement in the XY directions is likely to occur. The fixing by the press-fitting alone is thus firm in the Z direction but not necessarily firm in the XY directions.

By contrast, in the present embodiment, the terminal module 130 is fixed to the camera case 101 by adhesive bonding at the flange receiving portion 112a and the base flange portion 142, which are surfaces perpendicular to the Z direction, using the thermal adhesive film 160 in addition to the press-fitting. The fixing at the surfaces perpendicular to the Z-axis at a position distant from the press-fitting portion in the Z-axis direction in addition to the press-fitting provides fixation at two locations in the Z-axis direction (the press-fitting location and the thermally adhesively bonded location). Since one of the locations (the thermally adhesively bonded location) is fixed at the surfaces perpendicular to Z-axis, firm fixation can be achieved even against a force acting in the XY directions.

If, for example, the camera case 101 is made of a metal material different from that of the shell 140 or of a resin, the coefficient of linear expansion different from that of the metal shell 140 may cause a displacement due to expansion and the like at the contact surface between the camera case 101 and the terminal module 130 (the flange receiving portion 112a and the base flange portion 142) when the camera case 101 is subjected to external load or thermal load. However, the use of the thermal adhesive film 160 to adhesively bond the terminal module 130 to the camera case 101 at the flange receiving portion 112a and the base flange portion 142 makes displacement between the camera case 101 and the terminal module 130 less likely to occur even when the camera case 101 is subjected to external load or thermal load.

### Method for Fixing Terminal Module to Camera Case

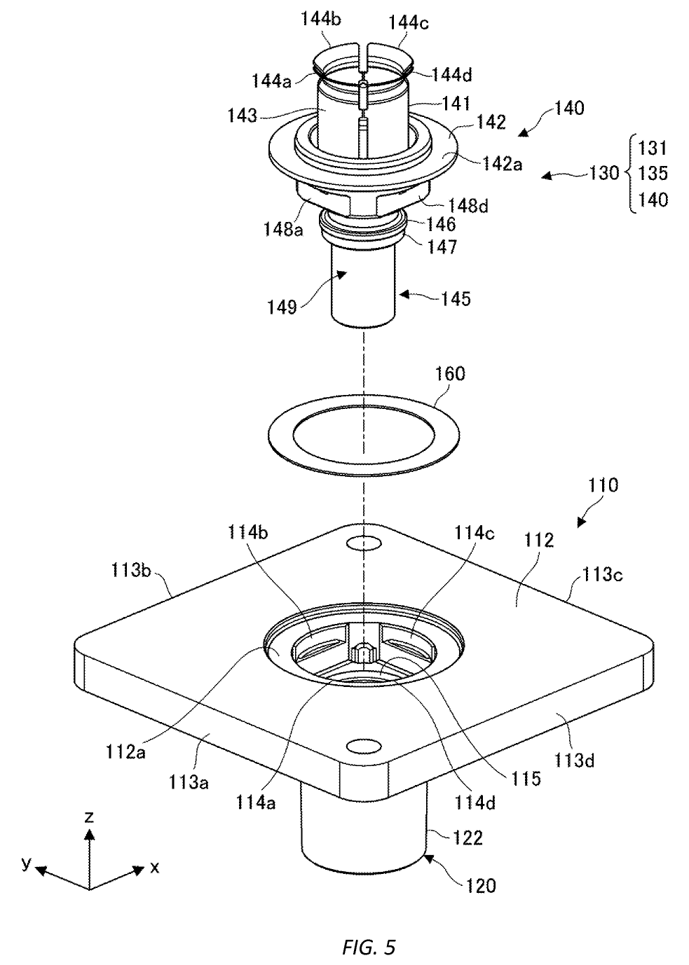

A method for fixing the terminal module to the camera case (hereinafter, also referred to simply as a fixing method) according to the present embodiment will now be described with reference to FIGS. 5 to 14. The fixing method according to the present embodiment includes a thermal adhesive film disposition step, a terminal module insertion step, a press-fitting step, a crimping step, and a heating step.

### Thermal Adhesive Film Disposition Step

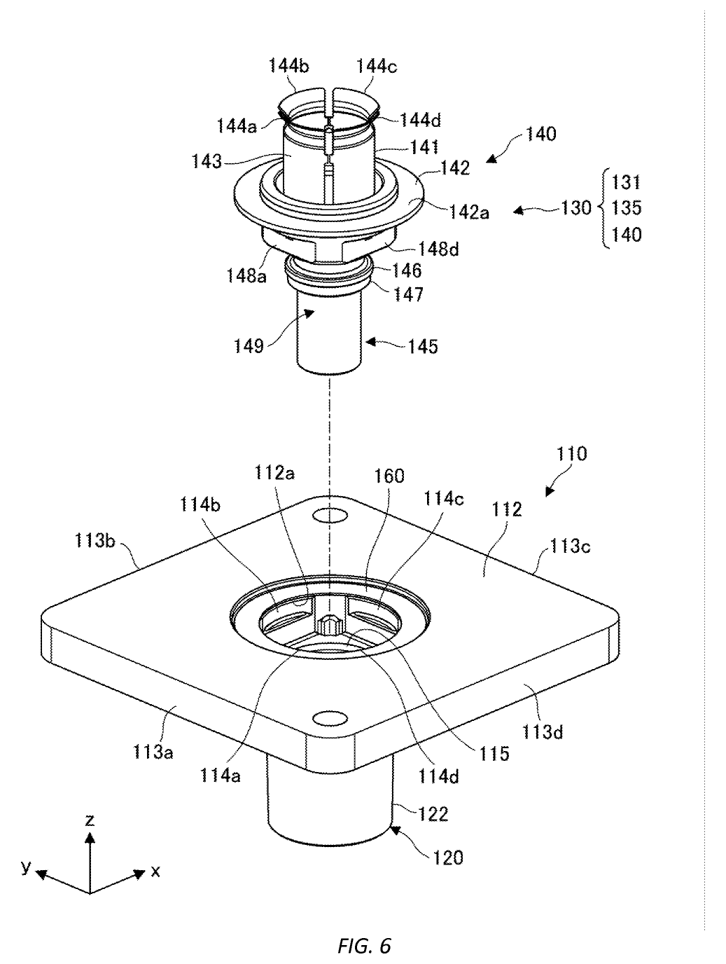

FIG. 5 is an exploded perspective view showing a state before the terminal module 130 is fixed to the camera case 101. In the thermal adhesive film disposition step, the thermal adhesive film 160 is disposed on the flange receiving portion 112a of the rear case 110 as shown in FIG. 6. Since the thermal adhesive film 160 has no tackiness at room temperature, the thermal adhesive film 160 can be easily adjusted in position.

### Terminal Module Insertion Step

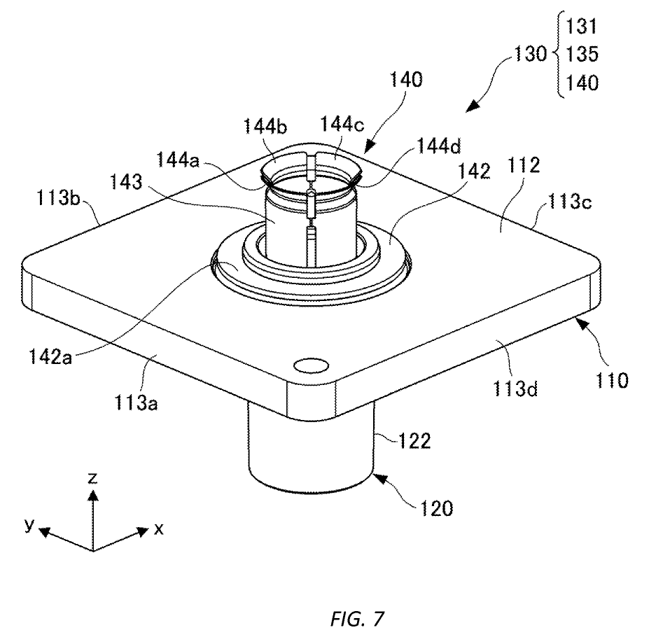

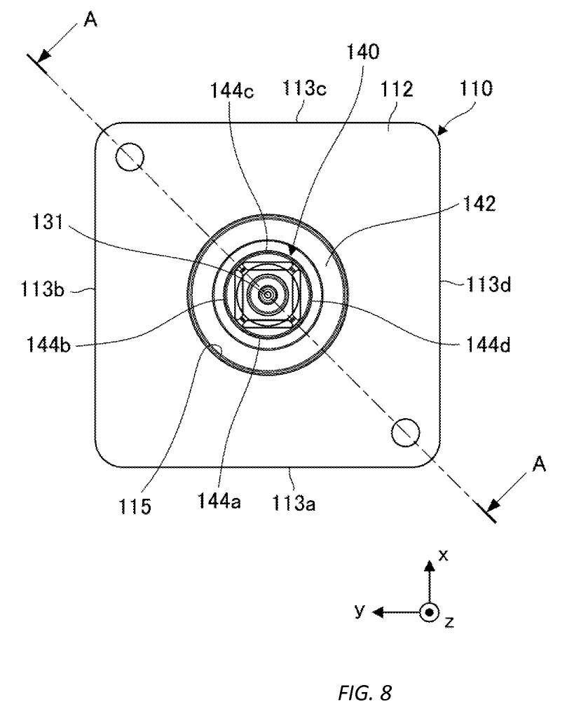

After the completion of the thermal adhesive film disposition step, the terminal module 130 is axially inserted, with the tip side ahead, into the through hole 115 and the housing 120 communicating with the through hole 115. FIG. 7 is a perspective view showing a state where the terminal module 130 is being inserted into the through hole 115 of the rear case 110 and the housing 120. FIG. 8 is a top view thereof. FIG. 9 is a sectional view taken along cross section A-A of FIG. 8. FIGS. 7 to 9 show a state during the insertion of the terminal module 130. As shown in FIG. 9, the base flange portion 142 is not yet in contact with the thermal adhesive film 160 on the flange receiving portion 112a. When the base flange portion 142 is inserted up to a position where the base flange portion 142 comes into contact with the flange receiving portion 112 via the thermal adhesive film 160 and the insertion is completed, the base flange portion 142 is in contact with the thermal adhesion film 160. Since heating is not yet performed in the insertion-completed state, the base flange portion 142 and the flange receiving portion 112a are not adhesively bonded with the thermal adhesive film 160, and the base flange portion 142 can be easily separated from the flange receiving portion 112a.

### Press-Fitting Step

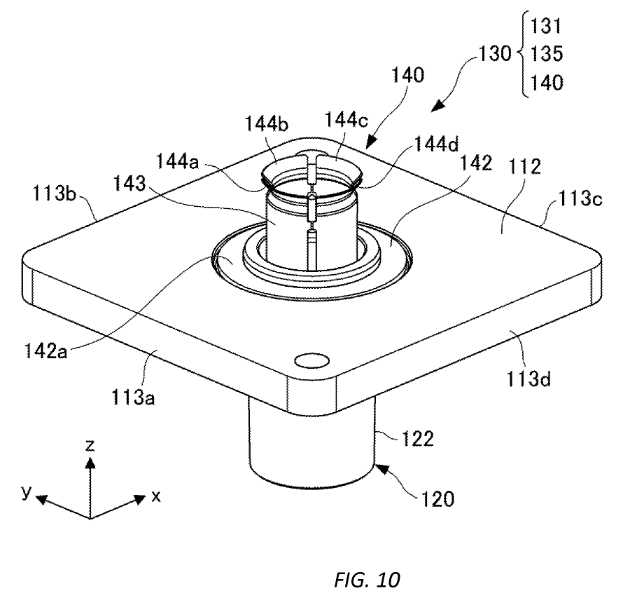

After the completion of the terminal module insertion step, the terminal module 130 is pressed toward the interior of the through hole 115 and the housing 120 and thereby press-fitted into the through hole 115 and the housing 120. The press-fitting is performed by using a not-shown known press-fitting jig or device. FIG. 10 is a perspective view showing a state where the terminal module 130 is press-fitted into the through hole 115 of the rear case 110 and the housing. FIG. 11 is a sectional view taken along a cross section at the same position as cross section A-A of FIG. 8. As shown in FIG. 11, with the first locking portion 146 of the shell 140 press-fitted into the housing 120, the first locking portion 146 catches on the first restriction portion 123, and as a result, the axial movement is restricted. After the completion of the press-fitting, the camera case 101 and the terminal module 130 will be more firmly fixed by crimping and the thermal adhesive film 160 as described below. However, even in the state where the press-fitting is completed, the camera case 101 and the terminal module 130 are fixed to a degree of not being easily separated.

### Crimping Step

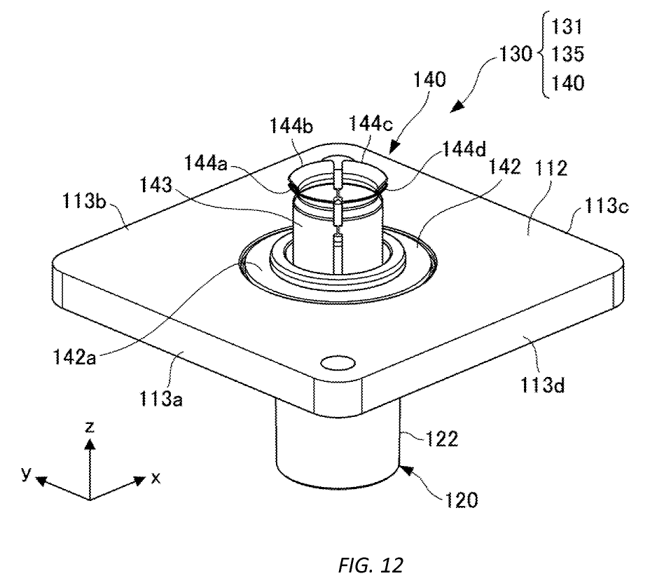

After the completion of the press-fitting step, the terminal module 130 is pressed toward the interior of the through hole 115 and the housing 120 for crimping. The crimping is performed by using a not-shown known crimping jig or device. FIG. 12 is a perspective view showing a state where the terminal module 130 is press-fitted into the through hole 115 of the rear case 110 and the housing 120 and then crimped. FIG. 13 is a sectional view taken along a cross section at the same position as cross section A-A of FIG. 8. As shown in FIG. 13, with the terminal module 130 crimped, the second locking portion 147 catches on the second restriction portion 124, and as a result, the axial movement is restricted. Even with the terminal module 130 crimped, the state of the press-fitted first locking portion 146 catching on the first restriction portion 123 is maintained. In the state where the crimping step is completed, the camera case 101 and the terminal module 130 are thus fixed more firmly than in the state where the press-fitting step is completed.

### Heating Step

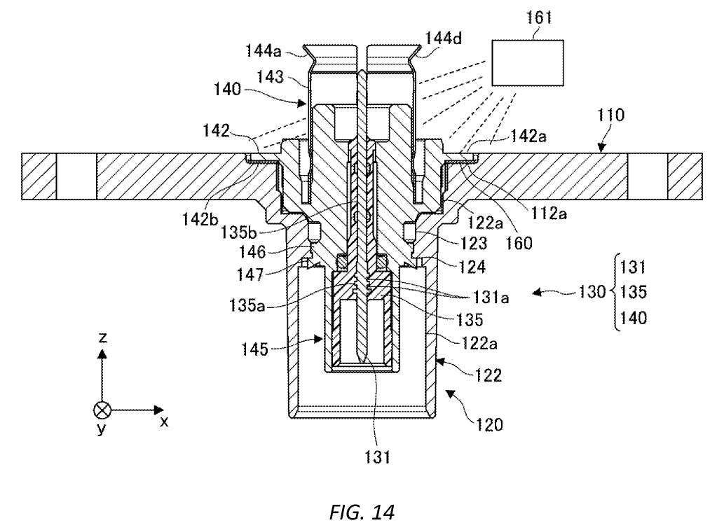

After the completion of the crimping step, the periphery of the flange receiving portion 112a is heated to heat the thermal adhesive film 160 sandwiched between the flange receiving portion 112a and the base flange portion 142, and as a result, the flange receiving portion 112a and the base flange portion 142 are adhesively bonded. FIG. 14 is a sectional view showing a state where the thermal adhesive film 160 is heated after the crimping of the terminal module to the through hole 115 and the housing 120, the sectional view being taken along a cross section at the same position as cross section A-A of FIG. 8. The heating is performed by using the induction heating device 161. The induction heating device 161 may be a known induction heating device, and can heat target members in a non-contact manner. The heating temperature may be determined based on the physical properties of the thermal adhesive film 160. For example, the heating temperature is 150°C or higher.

Completing the heating step can fix the flange receiving portion 112a and the base flange portion 142 by adhesive bonding due to the adhesive bonding function of the thermal adhesive film 160. This can also prevent water from entering through a gap between the flange receiving portion 112a and the base flange portion 142.

### Modifications of Method for Fixing Terminal Module to Camera Case

Modifications of the foregoing method for fixing the terminal module to the camera case will now be described.

### Modification 1

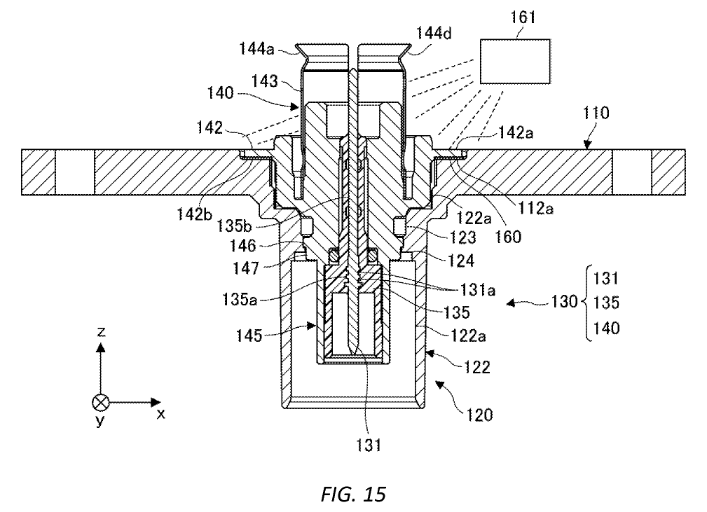

FIG. 15 is a sectional view showing a state where the thermal adhesive film 160 is heated while the terminal module 130 is being crimped to the through hole 115 of the rear case 110 and the housing 120, the sectional view being taken along a cross section at the same position as cross section A-A shown in FIG. 8. In this modification, the crimping step and the heating step are simultaneously performed, instead of the heating step being performed after the crimping step as described above. Performing the crimping of the terminal module 130 and the heating of the thermal adhesive film 160 at the same time can reduce the work time compared to when the steps are separately performed.

### Modification 2

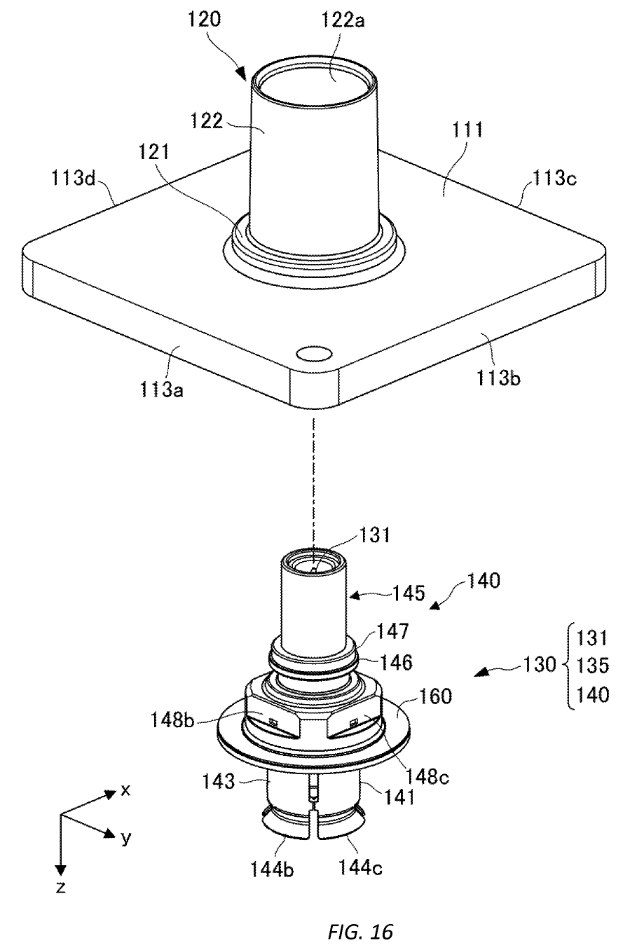

FIG. 16 is a perspective view showing a state where the thermal adhesive film 160 is disposed on the base flange portion lower surface 142b of the base flange portion 142. In this modification, unlike the foregoing thermal adhesive film disposition step, the thermal adhesive film 160 is disposed not on the flange receiving portion 112a but on the base flange portion lower surface 142b of the base flange portion 142. The thermal adhesive film 160 may be heated and adhesively bonded to the base flange portion 142 if needed. The terminal module insertion step, the press-fitting step, the crimping step, and the heating step after the thermal adhesive film disposition step are the same as those of the foregoing method.

### Other Modifications

As another modification, if the fixing strength of the camera case 101 and the terminal module 130 by press-fitting is sufficient, the heating step may be performed after the press-fitting step without the crimping step. Alternatively, the heating step may be performed while the press-fitting step is being performed.

As described above, in the method for fixing the terminal module 130 to the camera case 101 according to the present embodiment, the camera case 101 includes the rear case 110 that has the through hole 115 and includes the cylindrical housing 120 communicating with the through hole 115 and protruding outward, and the front case 102 that accommodates the image sensor 106, and is constituted by joining the rear case 110 and the front case 102. The terminal module 130 includes the shell 140 that is a cylindrical conductor having the base flange portion 142 at the base side with a diameter larger than at the tip side, the center contact 131 that is disposed inside and along the center axis of the shell 140, and the insulator 135 that is interposed between the shell 140 and the center contact 131 and holds the center contact 131.

The method for fixing the terminal module 130 to the camera case 101 according to the present embodiment includes the steps of: disposing the thermal adhesive film 160 configured to join a plurality of members made of the same material or different materials on the flange receiving portion 112a formed around the outer rim of the through hole 115 at the inner surface side of the rear case 110; inserting the terminal module 130, with the tip side ahead, into the through hole 115 up to a position where the base flange portion 142 comes into contact with the flange receiving portion 112a via the thermal adhesive film 160; after the insertion of the terminal module 130 into the through hole 115, further pressing the terminal module 130 toward the interior of the housing 120 and press-fitting the terminal module 130 into the through hole 115; after the press-fitting, pressing the terminal module 130 toward the interior of the through hole 115 and the housing 120 for crimping; and after the crimping, heating the periphery of the flange receiving portion 112a. In the step of press-fitting the terminal module 130 into the through hole 115, the press-fitting position of the terminal module 130 is restricted at the first locking portion 146 on the tip side of the terminal module 130 by the first restriction portion 123 formed on the cylindrical portion inner periphery 122a of the housing 120. In the step of pressing the terminal module 130 toward the interior of the through hole 115 and the housing 120 for crimping after the press-fitting, the crimping position of the terminal module 130 is restricted at the second locking portion 147 on the tip side of the terminal module 130 by the second restriction portion formed on the cylindrical portion inner periphery 122a of the housing 120.

With such a configuration, the method for fixing the terminal module 130 to the camera case 101 according to the present embodiment disposes the thermal adhesive film 160 on the flange receiving portion 112a of the rear case 110, inserts and then press-fits the terminal module 130 into the through hole 115, and heats the thermal adhesive film 160 sandwiched between the base flange portion 142 and the flange receiving portion 112a. The thermal adhesive film 160 is thereby softened, and the terminal module 130 and the rear case 110 are adhesively bonded and fixed to each other.

The method according to the present embodiment can thus reduce the assembly man-hours compared with a conventional method for fixing the terminal module to the camera case by attaching a seal member such as an O-ring to the periphery of the terminal module in advance, forming a locking structure configured to lock the seal member on the terminal module, deforming the locking structure to fix the seal member, and then inserting and press-fitting the terminal module into the camera case.

The adhesive bonding of the terminal module 130 and the rear case 110 at the base flange portion 142 and the flange receiving portion 112a prevents liquid from entering the interior of the camera case 101 from the exterior of the camera case 101 through the through hole 115, or conversely, liquid from flowing out from the interior of the camera case 101 to the exterior of the camera case 101 through the through hole 115, and as a result, the camera case 101 is provided with a waterproof function.

The thermal adhesive film 160 has no tackiness at room temperature and is easy to adjust in position. The thermal adhesive film 160 is thus relatively easy to dispose on the flange receiving portion 112a. Moreover, since the terminal module 130 can be fixed to the camera case 101 by simply heating the thermal adhesive film 160 after the terminal module 130 is press-fitted into the through hole 115 in the camera case 101, the operation is relatively easy.

By contrast, the conventional fixing using a double-sided tape or an adhesive is not an easy operation, because appropriate management of the attachment position, liquid amount, and the like is required and a high level of attention needs to be paid. Since the method according to the present embodiment includes the relatively easy operation steps, the workability during assembly can be improved.

The terminal module 130 is fixed at the base side by the base flange portion 142 being fixed to the flange receiving portion 112a with the thermal adhesive film 160, and at the tip side by the first locking portion 146 and the second locking portion 147 being restricted by the first restriction portion 123 and the second restriction portion 124 formed on the cylindrical portion inner periphery 122a of the housing 120. The terminal module 130 is thus firmly and stably fixed to the camera case 101 compared to when the terminal module 130 is fixed only at one end side.

The method for fixing the terminal module 130 to the camera case 101 according to the present embodiment may include a step of, after the terminal module 130 is inserted into the through hole 115, further pressing the terminal module 130 toward the interior of the housing 120 and press-fitting the terminal module 130 into the through hole 115 while heating the periphery of the flange receiving portion 112a.

With such a configuration, the method for fixing the terminal module 130 to the camera case 101 according to the present embodiment can reduce the work time by performing the press-fitting of the terminal module 130 and the heating of the thermal adhesive film 160 at the same time, compared with a case when the press-fitting and the heating are separately performed.

The method for fixing the terminal module 130 to the camera case 101 according to the present embodiment may include a step of disposing the thermal adhesive film 160 configured to join a plurality of members made of the same material or different materials on the base flange portion lower surface 142b that is the tip-side surface of the base flange portion 142.

A structure for fixing the terminal module 130 to the camera case 101 according to the present embodiment is a structure for fixing the terminal module 130 to the camera case 101, wherein the camera case 101 includes the rear case 110 that has the through hole 115 and includes the cylindrical housing 120 communicating with the through hole 115 and protruding outward, and the front case 102 that accommodates the image sensor 106, and is constituted by joining the rear case 110 and the front case 102. The terminal module 130 includes the shell 140 that is a cylindrical conductor having the base flange portion 142 at the base side with a diameter larger than at the tip side, the center contact 131 that is disposed inside and along the center axis of the shell 140, and the insulator 135 that is interposed between the shell 140 and the center contact 131 and holds the center contact 131. The terminal module 130 is fixed to the camera case 101 by being restricted at the tip side by the first restriction portion 123 and the second restriction portion 124 formed on the cylindrical portion inner periphery 122a of the housing 120, and by the base flange portion 142 and the flange receiving portion 112a formed around the through hole 115 at the inner surface side of the rear case 110 being adhesively bonded with the thermal adhesive film 160 configured to join a plurality of members made of the same material or different materials, sandwiched between the base flange portion 142 and the flange receiving portion 112a.

With such a configuration, in the structure for fixing the terminal module 130 to the camera case 101 according to the present embodiment, the terminal module 130 and the rear case 110 are adhesively bonded at the base flange portion 142 and the flange receiving portion 112a. This configuration prevents liquid from entering the interior of the camera case 101 from the exterior of the camera case 101 through the through hole 115, or conversely, liquid from flowing out from the interior of the camera case 101 to the exterior of the camera case 101 through the through hole 115, and as a result, the camera case 101 is provided with a waterproof function.

The terminal module 130 is fixed at the base side by the base flange portion 142 being fixed to the flange receiving portion 112a by the thermal adhesive film 160, and at the tip side by the first locking portion 146 and the second locking portion 147 being restricted by the first restriction portion 123 and the second restriction portion 124 formed on the cylindrical portion inner periphery 122a of the housing 120. The terminal module 130 is thus firmly and stably fixed to the camera case 101 compared to when the terminal module is fixed only at one end side.

As described above, the method for fixing a terminal module to a case containing an electronic device and the structure for fixing a terminal module to a case containing an electronic device according to the present invention have the effects of being able to provide a waterproof function and reduce the assembly man-hours when fixing the terminal module to the case containing the electronic device, and improve the workability during assembly, and are useful for methods for fixing a terminal module to a case containing an electronic device and structures for fixing a terminal module to a case containing an electronic device in general.

### REFERENCE SIGNS LIST

101 camera case (case containing electronic device)

102 front case (second case)

103 camera module

104 camera substrate

105 substrate-side connector

106 image sensor

107 external connector

107a cable

110 rear case (first case)

111 rear case front surface

112 rear case inner surface

112a flange receiving portion

113a, 113b, 113c, 113d rear case side surface

114a, 114b, 114c, 114d rear case engagement portion

115 through hole

120 housing

121 base housing portion

122 cylindrical portion

122a cylindrical portion inner periphery

123 first restriction portion (restriction portion)

124 second restriction portion

130 terminal module

131 center contact

131a engagement piece

135 insulator (insulating member)

135a insulator engagement portion

135b through hole

140 shell

141 base shell portion

142 base flange portion (flange portion)

142a base flange portion upper surface

142b base flange portion lower surface

143 base cylindrical portion

144a, 144b, 144c, 144d base piece

145 tip shell portion

146 first locking portion

147 second locking portion

148a, 148b, 148c, 148d notched engagement portion

149 tip cylindrical portion

160 thermal adhesive film

161 induction heating device

What is claimed is:

1. A method for fixing a terminal module to a case containing an electronic device, wherein
the case containing the electronic device includes a first case that has a through hole and includes a cylindrical housing communicating with the through hole and protruding outward, and a second case that accommodates an image sensor, the case being constituted by joining the first case and the second case,
the terminal module includes a shell that is a cylindrical conductor having a flange portion at a base side with a diameter larger than at a tip side, a center contact that is disposed inside and along a center axis of the shell, and an insulating member that is interposed between the shell and the center contact and holds the center contact, and
the method comprises the steps of:
disposing a thermal adhesive film configured to join a plurality of members made of a same material or different materials on a flange receiving portion formed around an outer rim of the through hole at an inner surface side of the first case;
inserting the terminal module, with the tip side ahead, into the through hole up to a position where the flange portion comes into contact with the flange receiving portion via the thermal adhesive film;
after the terminal module is inserted into the through hole, further pressing the terminal module toward an interior of the housing and thereby press-fitting the terminal module into the through hole; and
after the press-fitting, heating a periphery of the flange receiving portion.

2. The method according to claim 1, wherein, in the step of press-fitting the terminal module into the through hole, a press-fitting position of the terminal module is restricted at the tip side of the terminal module by a restriction portion formed on an inner periphery of the housing.

3. A method for fixing a terminal module to a case containing an electronic device, wherein
the case containing the electronic device includes a first case that has a through hole and includes a cylindrical housing communicating with the through hole and protruding outward, and a second case that accommodates an image sensor, the case being constituted by joining the first case and the second case,
the terminal module includes a shell that is a cylindrical conductor having a flange portion at a base side with a diameter larger than at a tip side, a center contact that is disposed inside and along a center axis of the shell, and an insulating member that is interposed between the shell and the center contact and holds the center contact, and
the method comprises the steps of:
disposing a thermal adhesive film configured to join a plurality of members made of a same material or different materials on a flange receiving portion formed around an outer rim of the through hole at an inner surface side of the first case;
inserting the terminal module, with the tip side ahead, into the through hole up to a position where the flange portion comes into contact with the flange receiving portion via the thermal adhesive film; and
after the terminal module is inserted into the through hole, further pressing the terminal module toward an interior of the housing and thereby press-fitting the terminal module into the through hole while heating a periphery of the flange receiving portion.

4. A method for fixing a terminal module to a case containing an electronic device, wherein
the case containing the electronic device includes a first case that has a through hole and includes a cylindrical housing communicating with the through hole and protruding outward, and a second case that accommodates an image sensor, the case being constituted by joining the first case and the second case,
the terminal module includes a shell that is a cylindrical conductor having a flange portion at a base side with a diameter larger than at a tip side, a center contact that is disposed inside and along a center axis of the shell, and an insulating member that is interposed between the shell and the center contact and holds the center contact, and
the method comprises the steps of:
disposing a thermal adhesive film configured to join a plurality of members made of a same material or different materials on a surface of the flange portion on the tip side;
inserting the terminal module, with the tip side ahead, into the through hole up to a position where the flange portion comes into contact with a flange receiving portion via the disposed thermal adhesive film, the flange receiving portion being formed around an outer rim of the through hole at an inner surface side of the first case;
after the terminal module is inserted into the through hole, further pressing the terminal module toward an interior of the housing and thereby press-fitting the terminal module into the through hole; and
after the press-fitting, heating a periphery of the flange receiving portion.

5. A structure for fixing a terminal module to a case containing an electronic device, wherein
the case containing the electronic device includes a first case that has a through hole and includes a cylindrical housing communicating with the through hole and protruding outward, and a second case that accommodates an image sensor, the case being constituted by joining the first case and the second case,
the terminal module includes a shell that is a cylindrical conductor having a flange portion at a base side with a diameter larger than at a tip side, a center contact that is disposed inside and along a center axis of the shell, and an insulating member that is interposed between the shell and the center contact and holds the center contact, and
the terminal module is fixed to the case containing the electronic device at the tip side by being restricted by a restriction portion formed on an inner periphery of the housing, and by the flange portion and a flange receiving portion being adhesively bonded with a thermal adhesive film sandwiched between the flange portion and the flange receiving portion, the flange receiving portion being formed around the through hole at an inner surface side of the first case, the thermal adhesive film being configured to join a plurality of members made of a same material or different materials.
